(19) United States
(12) Patent Application Publication
(10) Pub. No.: US 2016/0149877 A1
(43) Pub. Date: May 26, 2016

(54) SYSTEMS AND METHODS FOR CLOUD-BASED WEB SERVICE SECURITY MANAGEMENT BASEDON HARDWARE SECURITY MODULE

(71) Applicant: CAVIUM, INC., San Jose, CA (US)

(72) Inventors: Phanikumar KANCHARLA, Sunnyvale, CA (US); Ram Kumar MANAPRAGADA, Hyderabad (IN)

(21) Appl. No.: 14/299,739

(22) Filed: Jun. 9, 2014

Related U.S. Application Data
(60) Provisional application No. 62/008,112, filed on Jun. 5, 2014.

(51) Int. Cl. H04L 29/06; H04L 9/08

(52) U.S. Cl. CPC H04L 63/062; H04L 9/0819

(57) ABSTRACT

A new approach is proposed that contemplates systems and methods to support security management for a plurality of web services hosted in a cloud at a data center to offload their crypto operations to one or more hardware security modules (HSMs) deployed in the cloud. Each HSM is a high-performance, Federal Information Processing Standards (FIPS) 140-compliant security solution for crypto acceleration of the web services. Each HSM includes multiple partitions, wherein each HSM partition is dedicated to support one of the web service hosts/servers to offload their crypto operations via one of a plurality of HSM virtual machine (VM) over the network. An HSM managing VM can also be deployed to monitor and manage the operations of the HSM-VMs to support a plurality of web services.

### CROSS-REFERENCE TO RELATED APPLICATIONS

This application claims the benefit of U.S. Provisional Patent Application No. 62/008,112, filed Jun. 5, 2014, and entitled “Method And System For Cloud-Based Web Service Security Management Based On Hardware Security Modules (HSMs),” which is incorporated herein in its entirety by reference.

### BACKGROUND

As service providers increasingly host their web services (e.g., web sites) at third party data centers in the cloud such as Amazon Web Services (AWS) and Google Sites, security and key management for these web services hosted at the third party data centers has become an important issue. The crypto operations such as RSA, encryption and decryption operations required for secured communications with these web services consume a lot of CPU cycles and computing resources at the servers hosting the web services and are preferred to be offloaded to a separate module dedicated to that purpose.

Hardware security modules (HSMs) are physical computing devices that safeguard and manage keys for strong authentication and provide crypto processing capabilities. Each HSM traditionally comes in the form of a plug-in card or an external device that attaches directly to a computer or network server to offload key management and crypto operations from the server. However, hardware offloading is not always available especially for the web services hosted at third party data centers, since most servers at the data centers do not have hardware RSA accelerators. In addition, some hypervisor products for running virtual machines on the servers, such as vSphere by VMWare and Hyper-V by Microsoft, do not support non-networking single root I/O virtualization (SR-IOV), which enables a device to separate access to its resources among various Peripheral Component Interconnect (PCI) Express (PCIe) hardware functions, and thus making them very difficult to provide hardware offloading for crypto operations. Therefore, there is a need for an improved system and method to provide secured key management for cloud-based web services hosted at a third party data center via HSMs.

The foregoing examples of the related art and limitations related therewith are intended to be illustrative and not exclusive. Other limitations of the related art will become apparent upon a reading of the specification and a study of the drawings.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 depicts an example of a diagram of system 100 to support crypto operation offloading and acceleration for cloud-based web services via an HSM in accordance with some embodiments.

FIG. 2 depicts an example of hardware implementation of the system 100 depicted in FIG. 1 for cloud-based web service security management via the HSM in accordance with some embodiments.

FIG. 3 depicts a flowchart of an example of a process to support crypto operation offloading and acceleration for cloud-based web services via an HSM in accordance with some embodiments.

FIG. 4 depicts a diagram of an example of a process flow for the HSM to move from an initial reset state to an operational state in accordance with some embodiments.

FIG. 5 depicts a diagram of an example of a four-way handshake between a PF HSM driver and the HSM in accordance with some embodiments.

FIG. 6 depicts a diagram of an example of a four-way handshake between a VF HSM driver and the HSM partition in accordance with some embodiments.

### DETAILED DESCRIPTION

The following disclosure provides many different embodiments, or examples, for implementing different features of the subject matter. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

A new approach is proposed that contemplates systems and methods to support security management for a plurality of web services hosted in a cloud at a data center to offload their key storage, management, and crypto operations to one or more hardware security modules (HSMs) deployed in the cloud. Each HSM is a high-performance, Federal Information Processing Standards (FIPS) 140-compliant security solution for crypto acceleration of the web services. Specifically, each HSM can be a hardware/firmware multi-chip embedded cryptographic module, which provides cryptographic functionalities including but not limited to key management, modular exponentiation, random number generation, and hash processing, along with protocol-specific instructions to support various security protocols. In some embodiments, each HSM includes multiple partitions, where each HSM partition is dedicated to support one of the web service hosts/servers to offload their crypto operations via one of a plurality of HSM virtual machine (VM) over the network. The single HSM-VM establishes secure communication channels with both the web service host and the partition of the HSM, and enables the web service host to utilize the key management and cryptographic functionalities of the HSM. An HSM managing VM can also be deployed to monitor and manage the operations of the HSM-VMs to support a plurality of web services.

The proposed approach enables web service providers hosting their websites at a third-party data center to offload its key management and crypto operations to one or more cloud-based HSMs to save computing resources on the hosts of the websites. Importantly, the keys and credentials of each website are kept in a FIPS 140-2 compliant secured environment on the HSMs, which is accessible only by the website and the corresponding HSM dedicated to serve the web service host. Not even the third-party data center that hosts the web site is able to access its keys and credentials. Such an approach enables the offloading of the key management and crypto operations of the web service providers be accomplished in a highly secured manner.

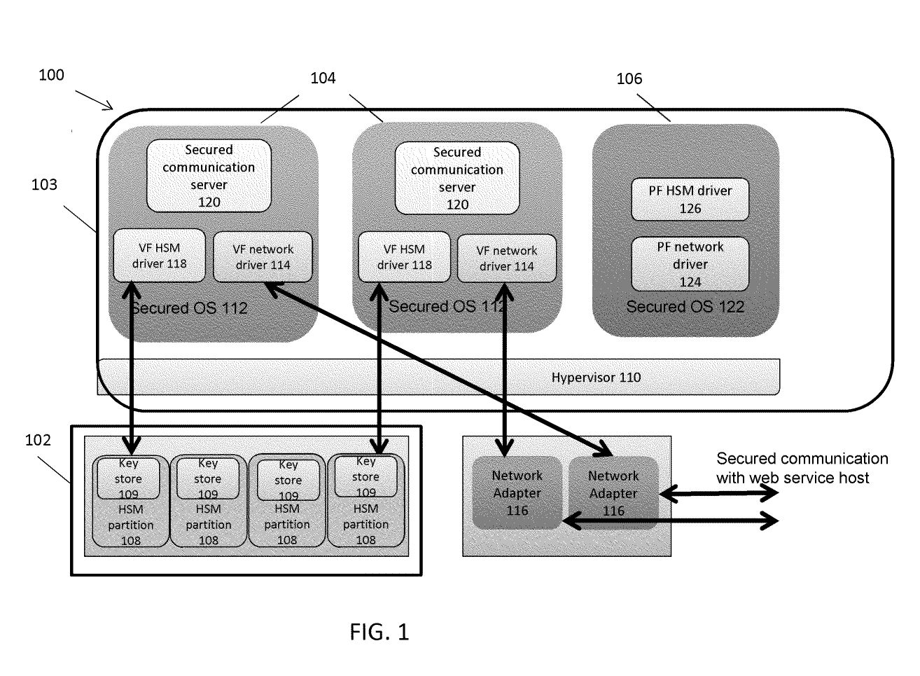

FIG. 1 depicts an example of a diagram of system 100 to support crypto operation offloading and acceleration for cloud-based web services via a hardware security module (HSM). Although the diagrams depict components as functionally separate, such depiction is merely for illustrative purposes. It will be apparent that the components portrayed in this figure can be arbitrarily combined or divided into separate software, firmware and/or hardware components. Furthermore, it will also be apparent that such components, regardless of how they are combined or divided, can execute on the same host or multiple hosts, and wherein the multiple hosts can be connected by one or more networks.

In the example of FIG. 1, the system 100 includes at least a hardware security module (HSM) 102, a plurality of HSM virtual machines (HSM-VMs) 104, and an HSM managing VM 106. In some embodiments, the HSM 102 is a multi-chip embedded hardware/firmware cryptographic module having software, firmware, hardware, or another component that is used to effectuate a purpose. The HSM-VMs 104 and the HSM managing VM 106 typically run on a computing unit/appliance/host 103 that is certified under Federal Information Processing Standard (FIPS) for performing secured cryptographic operations. The computing unit/appliance/host 103 comprises one or more of a CPU or microprocessor, a memory (also referred to as primary memory) such as RAM, and a storage unit such as a non-volatile memory (also referred to as secondary memory) with software instructions stored in for practicing one or more processes. When the software instructions are executed, at least a subset of the software instructions is loaded into memory, and the computing unit becomes a special purpose computing unit for practicing the processes. When implemented on a general-purpose computing unit, the computer program code segments configure the computing unit to create specific logic circuits. The processes may alternatively be at least partially embodied in a digital signal processor formed of application specific integrated circuits (ASIC) for performing the processes. For non-limiting examples, the host 103 can be a computing device, a communication device, a storage device, or any electronic device, wherein the computing device can be but is not limited to a laptop PC, a desktop PC, a mobile device, or a server machine such as x86 server, and the communication device can be but is not limited to a mobile phone.

In the example of FIG. 1, each of the HSM 102, the HSM-VMs 104, and the HSM managing VM 106 has a communication interface (as described below), which is a component that enables the components to communicate with each other and other devices/hosts/servers over a network (not shown) following certain communication protocols such as TCP/IP protocol. Such network can be but is not limited to, internet, intranet, wide area network (WAN), local area network (LAN), wireless network, Bluetooth, WiFi, mobile communication network, or any other network type. The physical connections of the network and the communication protocols are well known to those of skill in the art.

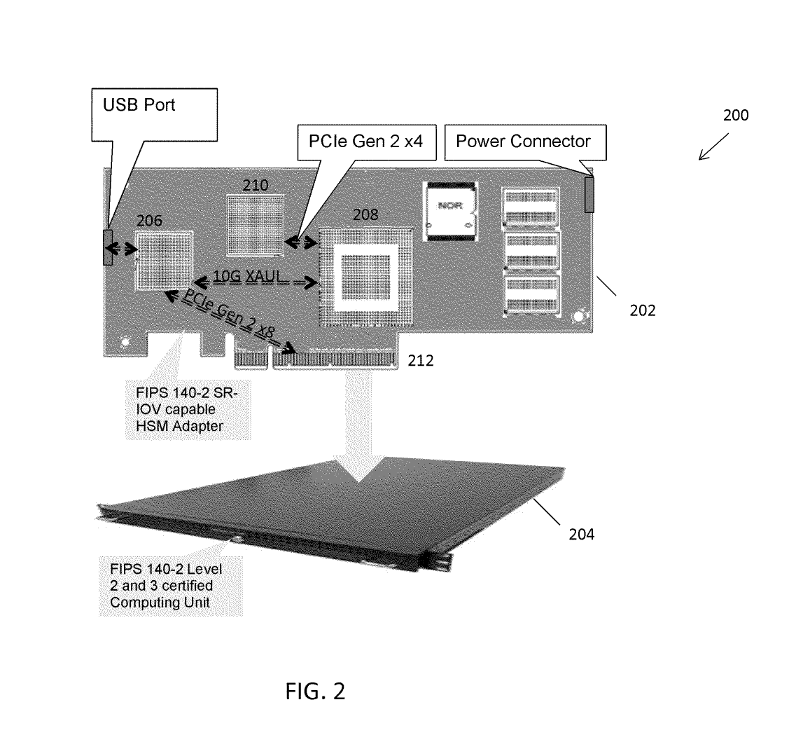

FIG. 2 depicts an example of hardware implementation 200 of the system 100 depicted in FIG. 1 for cloud-based web service security management via HSM. As shown in the example of FIG. 2, the FIPS-certified HSM appliance 200 includes an FIPS 140-2 Level 2 and 3 certified computing unit 204, having one or more CPUs, RAM, and storage unit and is configured to run multiple (e.g., up to 32) virtual machines such as the HSM-VMs 104, and the HSM managing VM 106. The HSM appliance 200 further includes a FIPS-certified SR-IOV-capable HSM adapter 202, which is the hardware appliance for the HSM 102. As shown in the example of FIG. 2, the HSM adapter 202 further includes an SR-IOV PCIe bridge 206 connecting the HSM Adapter 202 to the CPU in the computing unit 204 via a first PCIe connection (e.g., PCIe Gen2 x8), wherein PCIe is a high-speed serial computer expansion bus standard designed to support hardware I/O virtualization to enable maximum system bus throughput, low I/O pin count and small physical footprint for bus devices. The bridge 206 is further configured to connect to a multi-core processor 208 (e.g., a multi-core MIPS64 processor such as OCTEON CN6130) of the HSM Adapter 202 across a high speed communication interface (e.g., 10G XAUI Interface). The HSM adapter 202 further includes a security processor 210 (e.g., NITROX CNN3550) via a second PCIe connection (e.g., PCIe Gen 2 x4), wherein the security processor 210 is configured to enable cryptographic acceleration by performing crypto operations with hardware accelerators and embedded software implementing security algorithms. In some embodiments, the HSM appliance 200 is supplied and preconfigured with default network and authentication credentials so that the HSM appliance 200 can be FIPS compliant for crypto offloads as well as key and certificates storage.

In the example of FIG. 1, the HSM 102 is configured to provide a FIPS 140-2 overall Level 3 certified security solution to a plurality of web service providers/hosts by offloading key storage and cryptographic operations of the web service hosts. For a non-limiting example, the encryption/decryption key management is for symmetric and/or asymmetric (e.g., RSA) keys and the crypto operations to be accelerated are for cryptographic protocols such as Transport Layer Security (TLS) and/or Secure Sockets Layer (SSL) designed to provide communication security over the Internet. As shown in FIG. 2, the HSM Adapter 202 of the HSM 102 is physically connected to the computing unit 204 running the HSM-VMs 104 and the HSM managing VM 106 via a PCIe slot 212 in order to interact with and to provide high speed crypto acceleration to the web service hosts in a secure manner. The cryptographic functionalities provided by the HSM 102 include but are not limited to modular exponentiation, random number generation, and hash processing, along with protocol-specific instructions to support various security protocols such as TLS/SSL via the security processor 210 embedded in the HSM adapter 202. These cryptographic functionalities provided by the HSM 102 can be accessed by other components of system 100 via an Application Programming Interface (API) defined and provided by the HSM 102.

In some embodiments, the HSM 102 can be further divided into multiple HSM partitions 108, where each HSM partition 108 is dedicated to support one web service provider/host with one or more crypto acceleration units, an identity-based profile of one or more users, a key store 109 to accept and keep one or more of secured authentication credentials, user generated/imported keys, and configurations. Here, all passwords and/or credentials are stored and authenticated in the HSM partition 108 with nothing being stored anywhere else (e.g., the host 103 of the HSM-VMs 104) in the system 100. Consequently, no entity except the HSM partition 108 and the web service provider/host can have access to the authentication credentials.

In some embodiments, the HSM partitions 108 are soft partitions created by utilizing firmware of the HSM 102. The HSM 102 ensures that the HSM partitions 108 has the following security features:
The HSM partitions 108 have one-to-one correspondence with the HSM-VMs 104, wherein each HSM partition 108 interacts with and allows access from only one of the HSM-VMs 104. In some embodiments, a unique static secret (e.g., 12-byte long) is configured and assigned to each HSM-VM 104 during initialization of the system 100 and its drivers. Every subsequent request to an HSM partition 108 from a particular HSM-VM 104 is then checked against the static secret assigned to the particular HSM-VM 104 as well as a dynamic secret (e.g., 8-byte long) provided in real time during the interacting process between the HSM partition 108 and the HSM-VM 104.
A web service provider/host is required to open a communication session and authenticate itself over a secured communication channel with an HSM-VM 104 in order to be able to interact with and access a corresponding HSM partition 108 of the HSM 102. Here, duration of the communication session varies with every login attempt by the web service provider/host and the secured communication channel can only be established following a successful secured handshake between the web service provider/host and the HSM-VM 104. In some embodiments, the dynamic secret used to authenticate the HSM-VM 104 to the HSM partition 108 is also generated following the establishment of the secured communication channel.

In some embodiments, each HSM partition 108 supports and requires identity-based authentication for its operation as required by the FIPS 140-2 level 3. Each identity permits a different set of API calls for different types of commands used to initialize the partition, manage the partition, and/or provide crypto acceleration to the web service hosts. The types of commands made available by the HSM partition 108 vary based on the type of user logged into the HSM partition 108 and some API calls do not require any user login. For a non-limiting example, the HSM managing VM 106 may utilize different types of commands to initialize the HSM 102 and manage the HSM partitions 108 of the HSM 102.

In the example of FIG. 1, each HSM-VM 104 interacts with a web service provider/host via secured communication channels to offload key management and crypto operations of the web service provider/host to a specific HSM partition 108 of the HSM 102 dedicated to the HSM-VM 104. The HSM-VM 104 establishes secured connections and communicates with only one or more web service provider/hosts that have been authenticated by the HSM-VM 104 as discussed above. The HSM-VMs 104 run on top of a hypervisor 110, which runs the HSM-VMs 104 and HSM managing VM 106 on the host 103. The hypervisor presents each VM with a virtual operating platform and manages the execution of each VM on the host 103. Each HSM-VM 104 is a software implementation that executes programs to emulate a computing environment such as an operating system (OS).

In some embodiments, each HSM-VM 104 contains one or more of the following software components: a secured OS (e.g., Security Enhanced Linux or SE-Linux) 112, a virtual function (VF) network driver 114 configured to interact with a physical network adapter/card 116 of the host 103 to receive and transmit communications (e.g., packets) dedicated to the specific HSM-VM 104, and a VF HSM driver 118 configured to interact with an HSM partition 108 of the HSM 102 dedicated to the specific HSM-VM 104 and to set up a request/response communication path between the HSM-VM 104 and the HSM partition 108. The VF HSM driver 118 of the HSM-VM 104 and the HSM partition 108 of the HSM 102 communicate with each other through a SR-IOV PCIe bridge as discussed above, and each communication takes place in a FIPS-compliant way. As referred to herein, a VF driver is a lightweight PCIe function associated with the PCIe Physical Function (PF) on a network adapter (e.g., network adapter 116) that supports single root I/O virtualization (SR-IOV) and represents a virtualized instance of the network adapter. Each VF shares one or more physical resources on the network adapter, such as an external network port, with the PF and other VFs.

In some embodiments, the HSM-VMs 104 running on the same hypervisor 110 on the host 103 are isolated from each other and one HSM-VM 104 cannot access data/communication of any other HSM-VMs 104. During communication, packets received by the VF network driver 114 of an HSM-VM 104 from the physical network adapter 116 are filtered via a static destination MAC address, which is unique for each VF driver and cannot be changed/configured by the VF driver. The MAC address is delivered directly to the VF network driver 114 of the HSM-VM 104 based on SR-IOV mapping. When transmitting a packet from the HSM-VM 104, the VF network driver 114 directly puts the packet into a hardware queue, which is sent out of the physical network adapter 116 without the packet touching the host side or any other HSM-VMs 104 running on the same host 103.

In some embodiments, each HSM-VM 104 further includes a secured communication server 120 (e.g., a TurboSSL accelerated thin server) configured to establish a secured communication channel between the HSM-VM 104 and a server/host of a web service provider over a network. To ensure the secured communication, the secured communication server 120 adopts certificate-based mutual authentication between the HSM-VM 104 and the web service host and uses a restricted cipher set with the highest security. During its operation, the secured communication server 120 receives and converts every request from the web service provider into a command and passes the command to the HSM partition 108 dedicated to the HSM-VM 104 for further processing.

In the example of FIG. 1, the HSM managing VM 106 is configured to serve in an administrator role to manage the plurality of HSM-VMs 104 as well as various devices utilized by the HSM-VMs 104. Specifically, the HSM managing VM 106 determines the number of active HSM partitions 108 within the HSM 102, loads drivers for the various devices (e.g., physical network adapters 116 and the HSM 102) used to communicate with the HSM partitions 108, launches and monitors HSM-VMs 104 dedicated to the HSM partitions 108, and handles critical/management updates for the various devices. In some embodiments, the HSM managing VM 106 runs a secured OS (e.g., Security Enhanced Linux or SE-Linux) 122. In some embodiments, the HSM managing VM 106 includes a physical function (PF) network driver 124 configured to initialize the physical network adapters/cards 116 used by the VF network drivers 114 of the HSM-VMs 104 to communicate with their respective web service providers. As referred to herein, a PF driver is a PCIe function on a network adapter (e.g., network adapter 116) that supports SR-IOV interface. The PF driver is used to configure and manage the SR-IOV functionality of the network adapter such as enabling virtualization and exposing PCIe VFs.

In some embodiments, the HSM managing VM 106 further includes a PF HSM driver 126 configured to setup and initialize the HSM 102 for operating its HSM partitions 108 with the VF HSM drivers 118 of the HSM-VMs 104. The PF HSM driver 126 performs an initial handshake and establishes a request/response communication channel with the HSM 102. The PF HSM driver 126 identifies the number of active HSM partitions 108 in the HSM 102 and passes it to the HSM managing VM 106. If there are active HSM partitions 108 on the HSM 102, the HSM managing VM 106 checks the integrity of corresponding VM images, creates the plurality of HSM-VMs 104 each dedicated to one of the HSM partitions 108, and uses the commands available to initialize the HSM 102 and manage the HSM partitions 108 of the HSM 102. If no active HSM partition is available in the HSM 102, the HSM managing VM 106 launches no HSM-VM 104. The HSM managing VM 106 may subsequently create and/or remove HSM-VM 104 based on the number of HSM partitions available in the HSM 102 and/or the number of web service providers requesting to offload key management and crypto operations.

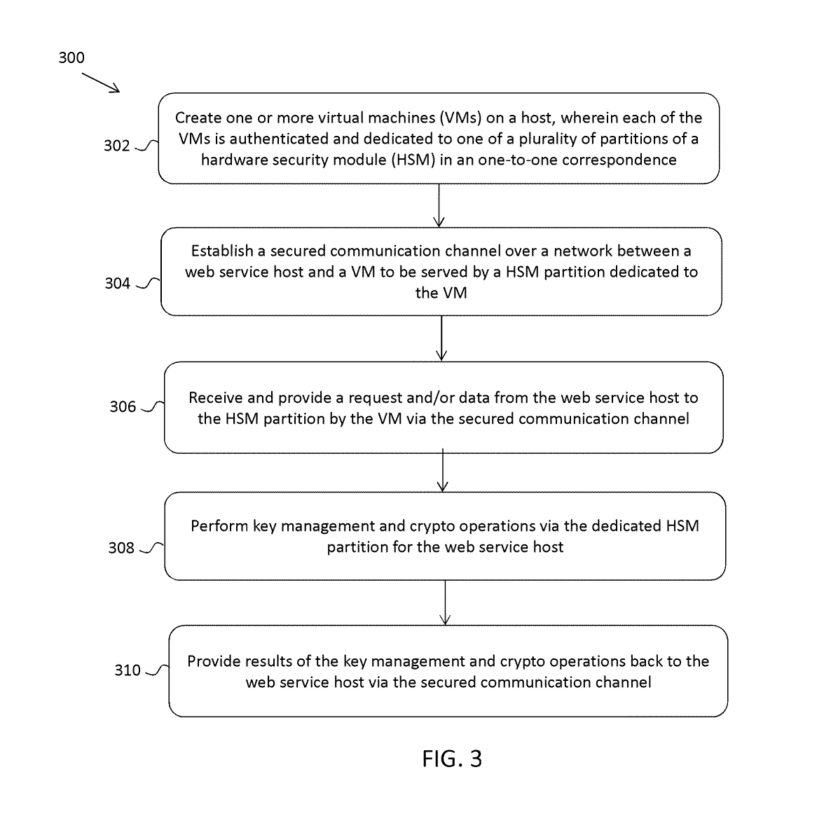

FIG. 3 depicts a flowchart of an example of a process to support crypto operation offloading and acceleration for cloud-based web services via an HSM. Although this figure depicts functional steps in a particular order for purposes of illustration, the process is not limited to any particular order or arrangement of steps. One skilled in the relevant art will appreciate that the various steps portrayed in this figure could be omitted, rearranged, combined and/or adapted in various ways.

In the example of FIG. 3, the flowchart 300 starts at block 302, where one or more virtual machines (VMs) are created on a host, wherein each of the VMs is authenticated and dedicated to one of a plurality of partitions of a hardware security module (HSM) in a one-to-one correspondence. The flowchart 300 continues to block 304, where a secured communication channel is established between each of the VMs and a web service host to be served by the HSM partition dedicated to the VM. The flowchart 300 continues to block 306, where a request and/or data from the web service host are received and provided to the HSM partition by the VM via the secured communication channel. The flowchart 300 continues to block 308, where key management and crypto operations are offloaded to and performed by the dedicated HSM partition for the web service host. The flowchart 300 ends at block 310, where results of the key management and crypto operations are provided back to the web service host by the dedicated VM via the secured communication channel.

While the system 100 depicted in FIG. 1 is in operation, the HSM managing VM 106 communicates with the HSM 102 to identify the number of active HSM partitions 108 available in the HSM 102. The HSM managing VM 106 then creates a plurality of HSM-VMs 104 on the host 103, wherein each of the HSM-VMs 104 is dedicated to and has a one-to-one correspondence with one of the HSM partitions 108 following proper authentication. The HSM managing VM 106 also initializes a plurality of network adapters/cards 116 used by the HSM-VMs 104 to communicate with web service providers. During its operation, each HSM-VM 104 establishes a secured communication channel with a web service host for receiving and transmitting packets of requests and data from and to the web service host. When an HSM-VM 104 receives a request from the web service host via its network adapter 116, the HSM-VM 104 converts the request into a command for the HSM 102 and passes the command to the HSM partition 108 dedicated to serve the HSM-VM 104 and the web service host. The dedicated HSM partition 108 maintains encryption/decryption keys as well as other credentials for the web service host in a FIPS 140-2 Level 3 certified environment. The HSM partition 108 further performs crypto operations including but not limited to key generations and bulk data encryption/decryption operations offloaded from the web service host. The HSM partition 108 then provides the results of the key and/or crypto operations back to the web service host through the secured communication channel established by the HSM-VM 104 via the network adapter 116.

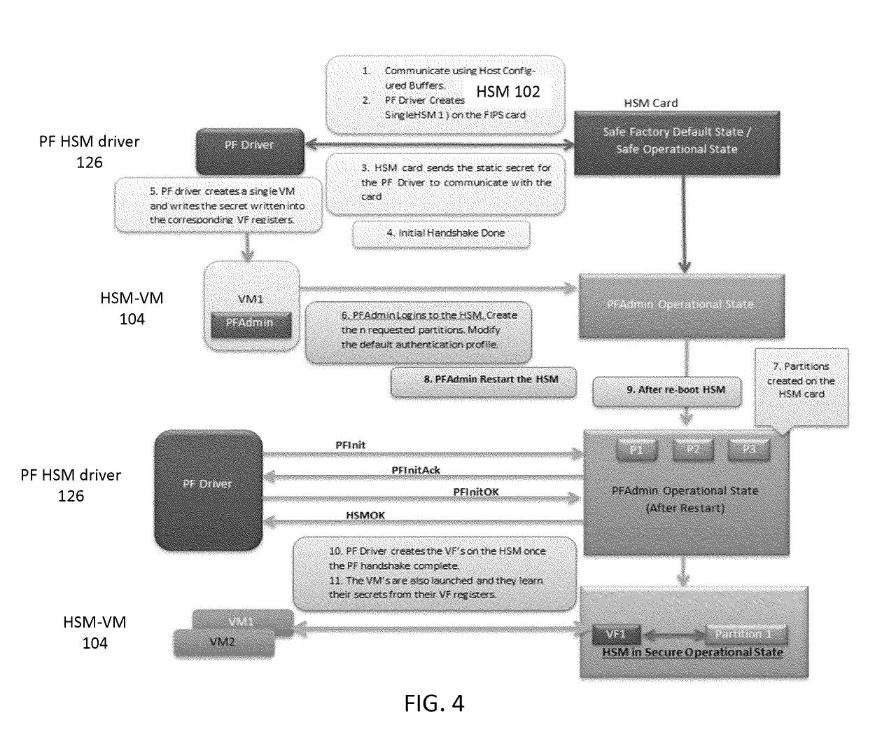

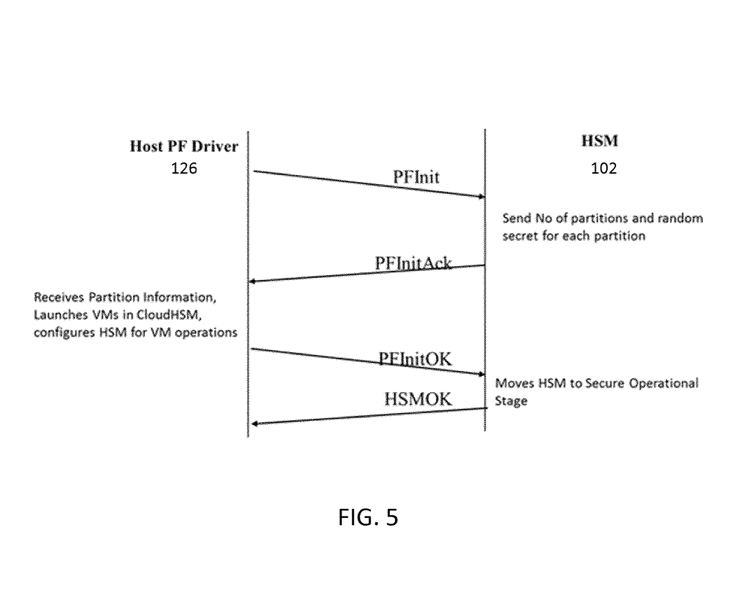

FIG. 4 depicts a diagram of an example of a process flow for the HSM 102 to move from an initial reset state to an operational state. Upon powering on, the HSM 102 moves through various states before it becomes accessible by HSM-VMs 104 to perform any cryptographic operations. The HSM 102 is in Safe Factory Default state when it is powered up for the very first time. When the HSM 102 is in this state or PFAdmin Operational state, where the HSM managing VM 106 creates the HSM partitions 108, the HSM 102 defines a messaging protocol that the PF HSM driver 126 of the HSM managing VM 106 follows to move the HSM 102 to a Secure Operational state and all communication between the PF HSM driver 126 and the HSM 102 takes place through host-configured buffers. FIG. 5 depicts a diagram of an example of a four-way handshake between the PF HSM driver 126 and the HSM 102. As part of the communication, the number of the HSM partitions 108 are provided to the HSM managing VM 106. The PF HSM driver 126 receives the number of the HSM partitions 108 and launches the plurality of HSM-VMs 104 in one-to-one correspondence with the HSM partitions 108. Also as part of this communication, the PF HSM driver 126 communicates one static secret per HSM partition 108 to each HSM-VM 104 to be used for authentication with the HSM partition 108. This static secret is configured on the HSM 102 for the specific HSM partition 108 and it cannot be read by another HSM partition 108. Once this exchange completes, the HSM 102 moves to Secure Operational state, where it is ready to perform key management and crypto operations.

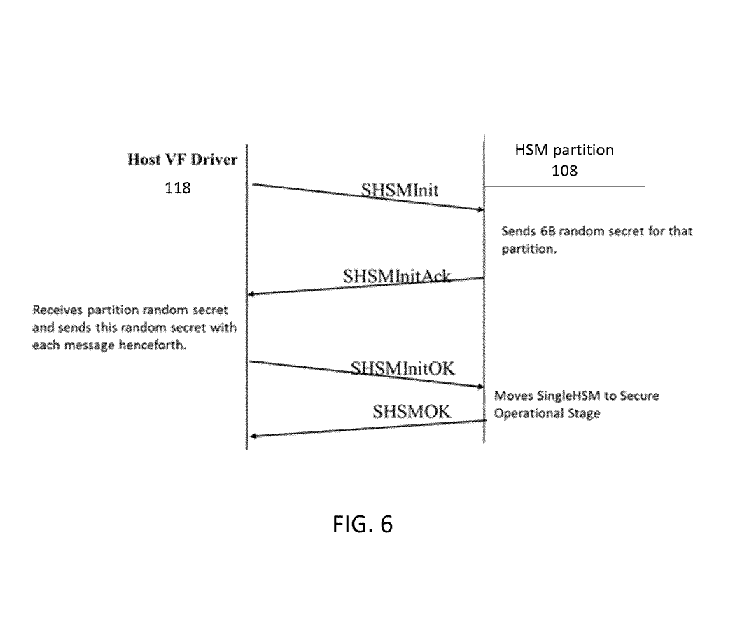

Similarly, each HSM-VM 104 and its corresponding HSM partition 108 also move from an initial reset state to an operational state, where the partition 108 can be accessed by its HSM-VM 104 for various cryptographic operations. The HSM-VM 104 is in SingleHSM Default state when the HSM 102 is being initialized by the HSM managing VM 106 for the first time. When in SingleHSM Default or SingleHSM Operational state, where the VF HSM driver 118 of the HSM-VM 104 has yet to initialize the HSM partition 108, the HSM 102 defines a messaging protocol that the VF HSM driver 118 follows to move the HSM partition 108 to Secure Operational state and all handshake communication between the VF HSM driver 118 and the HSM partition 108 takes place through VF-configured buffers. FIG. 6 depicts a diagram of an example of a four-way handshake between the VF HSM driver 118 and the HSM partition 108. As part of this handshake mechanism, a portion of a static secret is exchanged, which, in conjunction with the secret exchanged with the PF HSM driver 126 discussed above, forms a static secret that cannot be read by any other HSM partition 108. Once this exchange completes, the HSM-VM 104 moves to SingleHSM Secure Operational state, where the HSM-VM 104 work with its corresponding HSM partition 108 to perform key management and crypto operations offloaded from a web service host to the HSM-VM 104.

The methods and system described herein may be at least partially embodied in the form of computer-implemented processes and apparatus for practicing those processes. The disclosed methods may also be at least partially embodied in the form of tangible, non-transitory machine readable storage media encoded with computer program code. The media may include, for example, RAMs, ROMs, CD-ROMs, DVD-ROMs, BD-ROMs, hard disk drives, flash memories, or any other non-transitory machine-readable storage medium, wherein, when the computer program code is loaded into and executed by a computer, the computer becomes an apparatus for practicing the method. The methods may also be at least partially embodied in the form of a computer into which computer program code is loaded and/or executed, such that, the computer becomes a special purpose computer for practicing the methods. When implemented on a general-purpose processor, the computer program code segments configure the processor to create specific logic circuits. The methods may alternatively be at least partially embodied in a digital signal processor formed of application specific integrated circuits for performing the methods.

The foregoing description of various embodiments of the claimed subject matter has been provided for the purposes of illustration and description. It is not intended to be exhaustive or to limit the claimed subject matter to the precise forms disclosed. Many modifications and variations will be apparent to the practitioner skilled in the art. Embodiments were chosen and described in order to best describe the principles of the invention and its practical application, thereby enabling others skilled in the relevant art to understand the claimed subject matter, the various embodiments and with various modifications that are suited to the particular use contemplated.

What is claimed is:

1. A system for offloading key storage, management, and crypto operations for cloud-based web services, comprising:
a hardware security module (HSM), comprising one or more HSM partitions, wherein each of the HSM partitions is configured to perform key management and crypto operations for a web service host;
an HSM managing virtual machine (VM) running on a host, which in operation, is configured to create one or more HSM virtual machines (HSM-VMs), wherein each of the HSM-VMs is authenticated by and dedicated to one of the HSM partitions of the HSM in a one-to-one correspondence;
said one or more HSM-VMs running on a host, which in operation, is each configured to:
establish a secured communication channel over a network between the web service host and the HSM-VM to be served by an HSM partition dedicated to the HSM-VM;
receive and provide a request and/or data from the web service host to the HSM partition via the secured communication channel; and
provide results of the key management and crypto operations by the HSM partition back to the web service host via the secured communication channel.

2. The system of claim 1, wherein:
the HSM is a multi-chip embedded Federal Information Processing Standards (FIPS) 140-compliant hardware/firmware cryptographic module.

3. The system of claim 2, wherein:
the HSM includes a security processor configured to enable cryptographic acceleration by performing crypto operations with hardware accelerators and embedded software implementing security algorithms.

4. The system of claim 1, wherein:
the key management is for symmetric and/or asymmetric keys.

5. The system of claim 1, wherein:
the crypto operations are for cryptographic protocols designed to provide communication security over the Internet.

6. The system of claim 1, wherein:
the HSM partition includes one or more crypto acceleration units and a key store to keep one or more of secured authentication credentials, user generated/imported keys, and configurations.

7. The system of claim 6, wherein:
the secured authentication credentials, user generated/imported keys, and configurations are only stored in the key store within the HSM partition so that no entity except the HSM partition and the web service host has access to the authentication credentials.

8. The system of claim 1, wherein:
the HSM partition supports and requires identity-based authentication for its operation, wherein each identity permits a different set of API calls for different types of commands used to initialize the HSM partition, manage the HSM partition, and/or provide crypto acceleration to the web service host.

9. The system of claim 1, wherein:
the HSM managing VM and the HSM-VMs run on a host that is certified under FIPS for performing secured cryptographic operations.

10. The system of claim 1, wherein:
the HSM managing VM determines the number of active HSM partitions within the HSM, loads drivers for various devices used to communicate with the HSM partitions, launches and monitors the HSM-VMs dedicated to the HSM partitions, and handles critical/management updates for the various devices.

11. The system of claim 1, wherein:
the HSM managing VM comprises a physical function (PF) network driver configured to initialize the physical network adapters used by the HSM-VMs to communicate with their respective web service hosts.

12. The system of claim 1, wherein:
the HSM managing VM comprises a physical function (PF) HSM driver configured to setup and initialize the HSM for operating the HSM partitions with the HSM-VMs.

13. The system of claim 1, wherein:
each of the HSM-VMs is assigned a unique static secret used to authenticate with its corresponding HSM partition.

14. The system of claim 1, wherein:
the web service host is required to authenticate itself over the secured communication channel with the HSM-VM in order to be able to interact with and access the corresponding HSM partition.

15. The system of claim 1, wherein:
each of the HSM-VMs runs a Security Enhanced Linux operating system.

16. The system of claim 1, wherein:
each of the HSM-VMs comprises a virtual function (VF) network driver configured to interact with a physical network adapter of the host to receive and transmit communications dedicated to the HSM-VM.

17. The system of claim 1, wherein:
each of the HSM-VMs comprises a virtual function (VF) HSM driver configured to interact with an HSM partition of the HSM dedicated to the HSM-VM.

18. The system of claim 1, wherein:
each of the HSM-VMs comprises a secured communication server configured to establish the secured communication channel between the HSM-VM and the web service host over the network.

19. The system of claim 1, wherein:
the HSM-VMs running on the same hypervisor/host are isolated from each other and one HSM-VM cannot access data/communication of any other HSM-VMs.

20. A method for offloading key storage, management, and crypto operations for cloud-based web services, comprising:
creating one or more virtual machines (VMs) on a host, wherein each of the VMs is authenticated and dedicated to one of a plurality of partitions of a hardware security module (HSM) in a one-to-one correspondence;
establishing a secured communication channel over a network between a web service host and a VM to be served by an HSM partition dedicated to the VM;
receiving and providing a request and/or data from the web service host to the HSM partition by the VM via the secured communication channel;
performing key management and crypto operations via the dedicated HSM partition for the web service host; and
providing results of the key management and crypto operations back to the web service host via the secured communication channel.

21. The method of claim 20, further comprising:
storing secured authentication credentials, user generated/imported keys, and configurations only in a key store within the HSM partition so that no entity except the HSM partition and the web service host has access to the authentication credentials.

22. The method of claim 20, further comprising:
supporting and requiring identity-based authentication for operation of the HSM partition, wherein each identity permits a different set of API calls for different types of commands used to initialize the HSM partition, manage the HSM partition, and/or provide crypto acceleration to the web service host.

23. The method of claim 20, further comprising:
determining number of active HSM partitions within the HSM, loading drivers for various devices used to communicate with the HSM partitions, launching and monitoring the VMs dedicated to the HSM partitions, and handling critical/management updates for the various devices.

24. The method of claim 20, further comprising:
assigning each of the VMs a unique static secret used to authenticate itself with its corresponding HSM partition.

25. The method of claim 20, further comprising:
requiring the web service host to authenticate itself over the secured communication channel with the VM in order to be able to interact with and access the corresponding HSM partition.

26. The method of claim 20, further comprising:
isolating the VMs running on the same hypervisor/host from each other so that one VM cannot access data/communication of any other VMs.
